(19) United States
(12) Patent Application Publication
(10) Pub. No.: US 2026/0196109 A1
(43) Pub. Date: Jul. 9, 2026

(54) SYSTEMS AND METHODS FOR CHESS FANTASY GAME PLAY AND PEER TO PEER WAGERING

(71) Applicant: John Alphonse Lavarone, San Juan Capistrano, CA (US)

(72) Inventor: John Alphonse Lavarone, San Juan Capistrano, CA (US)

(21) Appl. No.: 18/831,424

(22) Filed: Oct. 3, 2024

(51) Int. Cl. G07F 17/32

(52) U.S. Cl. CPC G07F 17/3279; G07F 17/323; G07F 17/3237; G07F 17/3295

(57) ABSTRACT

A chess fantasy game play and peer-to-peer wagering system isprovided including a platform for novice players to play against the top players in the world for a fee. The platform determines a ranking and value for the novice and professional players based on player credentials and other statistical elements determining value and popularity. The platform also provides a peer-to-peer wagering platform where players can seek other players to wager against in online chess games.

### RELATED APPLICATION

This application claims priority to U.S. Provisional Application No. 63/590,851 filed Oct. 17, 2023 (the “'851 Application”) and incorporates by reference herein in full the disclosure of the '851 Application.

### INTRODUCTION

The Chess Fantasy Game Play and Peer-to-Peer Wagering System provides a new platform for novice players to play against the top players in the world for a fee. The platform will determine a ranking and value for the novice and professional players based on player credentials and other statistical elements determining value and popularity. Such data is used in an algorithm to determine the player value.

The platform also provides a peer-to-peer wagering platform where players can seek other players to wager against in online chess games. The platform provides certain unique wagering options to the players. The platform provides a player value system that determines parity between players that are considered for matches or allows players to create wagering odds based on the difference in value score between two players. The system provides compensation for professional celebrity players that wish to play against novice players for a fee.

The game/sport of chess is over 1500 years old and is estimated to have over 600 million players worldwide. Despite this reach and popularity, remarkably, the top chess players in the world have suffered limited financial opportunities due to the lack of commercialization. The game has not diversified into the mainstream like other sports that among other things have capitalized on wagering, fantasy sports play and fan interaction. The commercial value of the top players is far behind what we know as traditional professional athletes. Wagering is a leading factor in driving viewership and fan interaction across the internet and various social platforms. The lack of financial opportunities for professional players has caused many to revert to giving lessons and teaching chess to make a living, where other professional athletes make their living playing the game they are professionals in. The lack of a legal chess wagering platform has prevented players from wagering on the most popular game in the world. Moreover, novice players do not have a fantasy game allowing them to connect with the most popular player or become more emersed in their sport. The invention relates to the fantasy of novice chess players playing games against professional and celebrity players they would otherwise never have the opportunity to play. The game also provides a system of peer to peer wagering against players based on among other factors skill ratings.

Athletics and sports, game endeavors have long supported a broad range of secondary competitions which include wagering on the outcome of games and wagering on the performance of a particular player. There are fantasy camps whereby for a fee, players may take the field of play with current or former star players. Conventionally, the rules in a fantasy contest are set by a fantasy sports contest system provider. The fantasy sports system provider may also provide additional services, which include providing statistical information on real-life games and players, tracking users'scores, moves and ratings and enabling other players to utilize this information in selecting fantasy players to play against. These scoring elements are also used to select and determine player matchups between non-celebrity players for the purposes of peer-to-peer wagering. The statistics, data and ratings are among the elements players may use to select their opponents and ensure an even match, while some players may elect to play against players with higher ratings. The performance in these real-life competitions determines the user's rating within the fantasy and wagering platforms. It would therefore be desirable to present a fantasy chess contest system that actively aids the user in managing and improving performance and selecting opponents.

### SUMMARY

In view of the foregoing, it is therefore an object of the present invention to provide a user with a unique chess fantasy and wagering experience.

The fantasy chess and peer-to-peer wagering application of the present invention may be implemented on any suitable platform, or on any suitable combination of platforms. For example, in an interactive television or live stream system, the fantasy chess and peer-to-peer wagering contest application may be implemented using a multichannel set-top box receiver, a television capable of running software programs, a two-way remote control, any other suitable device or any suitable combination of devices. In another example of a suitable platform, the fantasy chess peer-to-peer wagering contest application may be implemented using the internet and any personal computer, mobile phone or device capable of internet access and a downloadable application. The fantasy chess wagering contest application of the present invention may access data from a statistical database and a contest database. The statistical database may store up-to-date information and statistics for all real-life players used in a fantasy chess wagering contest. The contest database may store fantasy chess wagering contest information, such as player ratings, opening strategies, number of moves, opponent ratings and contest rules.

In one embodiment of the present invention, the fantasy chess and peer-to-peer wagering contest application may aid the user by identifying necessary changes to the user's fantasy chess wagering opponent difficulty rating. In one suitable approach, the fantasy chess wagering contest application may evaluate the user's prior opponents before an upcoming match of the fantasy chess wagering contest to ensure or evaluate the ratings or skill level of players being considered for a match. An available player may search the player rosters for matches that meet the skill level or desire of the player seeking a match. Based on the player history, profile and prior performances, when new players enter the system with matching or similar skill sets or profile criteria, the player may receive alert messages to investigate or evaluate these players and determine to challenge to a match. This information contained in the alerts may be stored for future access.

In another suitable approach, the fantasy chess and peer-to-peer wagering contest application may recommend players and matches based on an evaluation of the performance of all players on the system roster through basic or customizable performance criteria. The performance criteria can be based on the past performance of players, either overall, or for certain criteria. The performance criteria may be predefined or determined by the system, user-editable, or any suitable combination thereof. For example, if the fantasy chess wagering contest application identifies a player who, according to performance criteria, may perform better in the next competition based on previous strategies, or common opponents. The fantasy chess and peer-to-peer wagering contest application may generate a recommendation message for display to the user detailing why a particular player presents a favorable match. Similarly, the fantasy chess wagering contest application may evaluate a pool of players and categorize them as not being suitable or practical matches based on the player rating and performance criteria. For example, because traditional chess play relies on player ratings, the player may receive performance data of common opponents, and ratings placing a player in a skill category that is above or below their skill level.

In another suitable approach, the fantasy chess and peer-to-peer wagering contest application may provide fantasy chess wagering contest users with information that would help guide with wagering and loss mitigation. In one suitable approach, a match recommended by the fantasy chess wagering contest application may be deemed, using performance criteria, to be a high-risk opponent and recommend a conservative wager. The fantasy chess and peer-to-peer wagering application may also recommend a player be given favorable odds based on the player(s) rating from the system. For example, a player with a 1500 rating may offer a player with an 1100 rating two to one odds, meaning that the higher rated player would risk losing $2.00, while the lower rated player would only risk losing $1.00.

The fantasy chess and peer-to-peer wagering application of the present invention may include certain customizable scoring features. Such scoring features may include receiving additional points for accomplishing game milestones such as taking the king or taking the queen. Other features may include a tournament manager feature, whereby an individual may invite multiple players to participate in a bracket format contest whereby scoring and elimination may be customized by the tournament manager using the manager tools in the system database.

The fantasy chess and peer-to-peer wagering application of the present invention may include certain game functions that allow the players to terminate the game using traditional chess game functions. In one suitable approach the fantasy chess wagering contest application may offer a draw to the opposition player, thereby forfeiting the victory for a tied outcome between the two players. Other moves within the game, may provide points or rewards determined in advance by the game system or may be customized by the players.

The fantasy chess and peer-to-peer wagering application of the present invention may include a live face to face video feed that allows real time interaction and communication between the players. In one suitable approach, this interaction provides a unique player experience in fantasy sports in general. Through this live face to face feed, the player will be able to have live interaction with chess professionals and celebrities which creates a unique player or fan experience.

The fantasy chess and peer-to-peer wagering application of the present invention may provide a system for determining the fantasy value of the professional celebrity player. The fantasy value may apply to the fee the chess player pays to play the professional celebrity player. The system will utilize certain data which may include chess rating, popularity on the platform, social media followers or other data derived from the performance on the platform or other external factors to create a value score. The value score may then be translated to a monetary amount that is charged to the player wanting to play the professional celebrity player. The professional celebrity player may be compensated with a percentage of the value score fantasy player fee. The value score is updated periodically as a system policy, which may be similar to the real time value of shares traded in the stock market. The fantasy chess contest and wagering application of the present invention may provide instant game play opportunities withing the game, such as instant rematch. The professional celebrity player may accept or deny the request for a rematch. The fantasy chess and peer-to-peer wagering application of the present invention provides players in a peer-to-peer wagering match the opportunity for a “bump bet” or raise of the current stakes of the game. For example, Player A is playing player B for a wager of $10.00. After each player has had at least one move to open the game, either play may propose to raise the stakes of the game in a predetermined increment, e.g. player A proposes to raise the bet $10 for a total wager of $20. Player B may accept or decline bump bet. The fantasy chess and peer-to-peer wagering application of the present invention provides players in a peer-to-peer wagering match the opportunity for double or nothing rematch, e.g., player A loses the $10 wager and offers a double or nothing rematch to player B, meaning if he wins he owes player B nothing, if he loses he owes player B double the original bet, which in this case is $20.

The fantasy chess and peer-to-peer wagering application of the present invention as it pertains to peer-to-peer wagering contests, the system will facilitate the financial transactions between the players, e.g., as in the example above, the system will deduct the losses from the winning player account and credit the account of the winning player with the wager amount. The system will assist the player(s) in managing their account balances with real-time information based on wins and losses. The system may alert players when their account balance falls below a certain threshold determined by the system or customized by the player. The system may include financial options authorized by players that will automatically withdraw amounts from their chosen method of payment to maintain a certain account balance. The fantasy chess and peer-to-peer wagering application of the present invention provides a points or rewards system that rewards players through certain performance criteria. In one suitable approach, players may accumulate rewards points for the number of games played over a period of time, the number of wins over a period of time, the average difficulty rating of opponents, referrals of new players, the popularity and match requests from other players to play the player receiving award points. In one suitable approach, the rewards points may be redeemed on the platform for among other things, tournament fees, fantasy player currency, or coupons and credits for goods and services provided by third party partners, e.g., fast food companies, hotels, airline, and other sponsor partners.

Further features of the invention, its nature, and various advantages will be more apparent from the accompanying drawings and the following detailed description of the preferred embodiments.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is a diagram of an illustrative fantasy chess and peer-to-peer wagering contest system in accordance with one embodiment of the present invention;

FIG. 2 is a diagram of an illustrative fantasy chess and peer-to-peer wagering contest internet system in accordance with one embodiment of the present invention;

FIG. 3 is a diagram of an illustrative fantasy chess and peer-to-peer wagering contest internet server system having network nodes in accordance with one embodiment of the present invention;

FIG. 4 shows an illustrative professional and celebrity player roster sample for selection as well as a peer-to-peer wagering roster of recent opponents played on the platform by the end user or challenger;

FIG. 5 is an illustration of buttons that would be present on a video display screen, some of which are functional and pertain to fantasy game play and peer-to-peer wagering, as well as a personal computer display screen to show such necessary functioning contest elements;

FIG. 6 is a diagram demonstrating the user acting as a tournament manager to select and edit game play criteria and rules;

FIG. 7 is a diagram of the rating system used by the game platform to determine fantasy player value;

FIG. 8 is a diagram of the movable pieces of the game of chess, that may be selected on a chance basis within the normal game.

### DETAILED DESCRIPTION

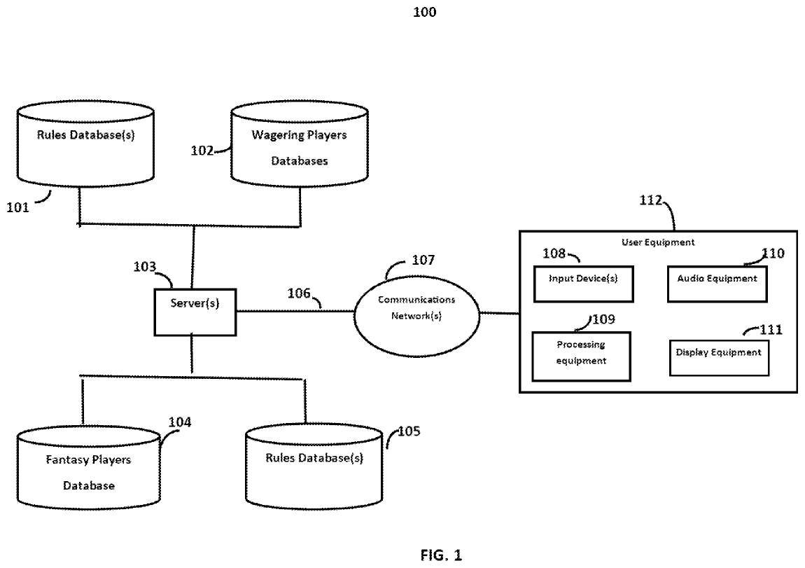

The present invention is primarily described herein in terms of fantasy chess and peer-to-peer wagering contest application. It will be understood that any other suitable software, hardware, or both may be used in conjunction with the fantasy chess and peer-to-peer wagering contest application or in place of the fantasy chess and peer-to-peer wagering contest application to implement some or all of the features of the present invention. The fantasy chess and peer-to-peer wagering contest application of the present invention may be any suitable software, hardware, or both that may be used to implement the features of the present invention. The fantasy chess and peer-to-peer wagering contest application may be implemented at any suitable location in the system described in FIG. 1. For example, the fantasy chess and peer-to-peer wagering contest application may be implemented at user equipment 112, at server 103, or at any other suitable location (that is not necessarily shown in FIG. 1), or at any combination of locations. For example, certain portions of the fantasy sports contest application may be implemented at user equipment 112 (e.g., those portions that implement features involved in user interaction), whereas certain other portions of the fantasy chess and peer-to-peer wagering contest application may be implemented at server 103 (e.g., those portions that implement features involved in the processing of client requests and in the tracking of the performance of contestants). Any such suitable arrangement of the fantasy chess and peer-to-peer wagering contest application may be implemented in accordance with the present invention.

The fantasy chess and peer-to-peer wagering contest application of the present invention may be used to implement fantasy chess and peer-to-peer wagering contests that include any suitable chess contest in which the user is given the ability to make decisions that may affect the standing of the user in the games contest. For example, in typical chess contests, the user may participate in the capacity of a player or challenger. In this situation, the user may select opponents based on criteria generated from performance data. In other examples, the user may act as a tournament manager and have responsibilities such as player selection using data generated on the system, the number of players in the tournament, the game play rules, which may include, time limits, brackets or contest fees. It will be understood that any other suitable decision-making capability may be given to the user in a fantasy chess and peer-to-peer wagering contest in addition to or in place of those indicated above. The chess and peer-to-peer wagering contest of the present invention need not be limited or restricted in time. For example, a fantasy chess and peer-to-peer wagering tournament may last an undefined period of time based on the number games played within the tournament rules as set forth by the tournament manager.

In one suitable approach, fantasy chess and peer-to-peer wagering contests may include contests in which the user is not necessarily playing the role of a tournament manager. For example, fantasy chess and peer-to-peer wagering contests may involve the user determining or guessing (i.e., blindly or with calculation) whether particular outcomes will occur (e.g., the opening move, whether or not the queen will be taken). The fantasy chess and peer-to-peer wagering contests of the present invention may use any suitable one or more scoring systems. For example, fantasy chess scoring systems may include straight point systems (e.g., points are awarded and subtracted based on real-life chess piece coming off the board), (e.g., points are awarded based on the user's relative ranking against other users), head-to-head systems (e.g., users in a tournament are matched against one another in a round-robin series of one-on-one contests during the course of a tournament). There are merely illustrative scoring systems. Any other suitable scoring system may be used in the fantasy chess and peer-to-peer wagering contests of the present invention. It will be understood that the above are merely illustrative elements of fantasy chess and per-to-peer wagering contests. The fantasy chess and peer-to-peer wagering contest application of the present invention may provide to the user fantasy chess and peer-to-peer wagering contest information. Fantasy chess and peer-to-peer wagering contest information may include any suitable information associated with one or more professional celebrity players or wagering opponents. For example, fantasy chess and peer-to-peer wagering contest information may include information regarding the players competitive profile, popularity or value, in which the user uses information to determine which players to challenge or what a fantasy value should be.

An illustrative fantasy sports contest system 100 in accordance with the present invention is shown in FIG. 1. A fantasy sports contest application may be at least partially implemented on server 103 in system 100. Server 103 may include any suitable one or more servers. For example, server 102 may include personal computers, high-capacity data storage servers, mainframe computers, computer networks (e.g., local area network, wide area network, intranet, etc.). Server 102 may access one or more databases (e.g., databases 101, 102, 104, and 105) that may be used to store information related to fantasy chess and peer-to-peer wagering. Databases 101, 102, 104, and 105 may reside on server 103, may partially reside on one or more servers 103, or may reside remote to server 103. Databases 104 may be used to store information relating to the fantasy chess and peer-to-peer wagering contest, such as player ratings, the value score, and any other information related to the fantasy chess and peer-to-peer wagering contest.

Database 104 may be used to store real-life statistical information, fantasy chess and peer-to-peer wagering contest statistical information, or other statistical information in relation to the fantasy chess and peer-to-peer wagering contest. Database 102 may be used to store player information such as the wagering opponents on available player profile and include profile information as well as past performance data.

Database 105 may be used to store information on rules of the fantasy chess and peer-to-peer wagering contest. The user of a fantasy chess and peer-to-peer wagering contest application may communicate with server 103 over communications network 107.

Communications network 107 may include any suitable communications network. For example, communications network 107 may include a satellite link, a telephone network link, an Internet link, a cable or fiber optic link, a microwave link, a combination of such links, or any other suitable communications path. Communications network 107 may include any suitable routers, proxies, any other suitable devices, or any combination thereof (e.g., gateway servers, domain name servers, Internet service provider proxy servers, etc.). The fantasy chess per-to-peer wagering contest information transmitted by server 103 to user equipment 112 includes data communicated to users as part of the fantasy chess peer-to-peer wagering contest such as statistical information, player rosters, standings, etc. If desired, some of the fantasy chess peer-to-peer wagering contest information may be provided using data sources at facilities other than server 103, and which are directly connected to user equipment 112 via communications network 107. Server 103 may distribute the fantasy chess and peer-to-peer wagering contest application and related data, as well as fantasy chess peer-to-peer wagering contest information to user equipment 112 via communications network 107. User equipment 112 at each user's location may include processing equipment 109. Processing equipment 109 may be based on as personal computer, a mobile phone, a personal computer television (PC/TV), a handheld computing device, etc. Processing equipment 109 may be used to implement the fantasy chess and peer-to-peer wagering contest application at the user's location.

Alternatively, the fantasy chess and peer-to-peer wagering contest application may be partially implemented on server 103 and partially implemented on processing equipment 109.

A number of suitable techniques may be used to distribute fantasy chess and peer-to-peer wagering contest information. For example, fantasy chess and peer-to-peer wagering contest information may be distributed from server 103 in a continuously looped arrangement, where the fantasy chess and peer-to-peer wagering contest application implemented on user processing equipment 109 may capture appropriate fantasy chess and peer-to-peer wagering sports contest information for display from the stream of fantasy sports contest information being transmitted. With such a continuously looped arrangement, a map indicating the location of the latest fantasy chess and peer-to-peer wagering contest information may be downloaded periodically to user equipment 112. This allows any databases used in server 103 for storing fantasy chess and peer-to-peer wagering contest information to be updated. Fantasy chess peer-to-peer wagering contest information may be downloaded to user equipment 112 periodically and stored locally. The fantasy chess and peer-to-peer wagering contest information may be accessed locally when needed by the fantasy sports contest application implemented (at least partially) using processing equipment 109 at the user's location. Another suitable approach involves using the fantasy chess and peer-to-peer wagering contest application to request fantasy chess and peer-to-peer wagering contest information as needed. Information on the location of fantasy chess and peer-to-peer wagering contest information may be downloaded to user equipment 112 and may be updated as needed. The fantasy chess and peer-to-peer wagering contest application implemented (at least partially) using processing equipment 109 may then request and receive, as needed, appropriate fantasy chess and peer-to-peer wagering contest information.

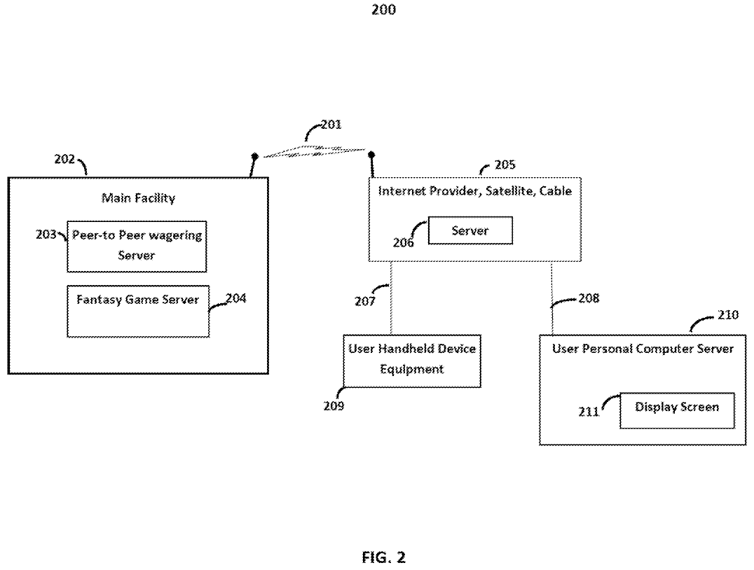

At the user's location, display equipment 111 may display to the user screens generated by the fantasy chess and peer-to-peer wagering contest application having fantasy chess peer-to-peer wagering contest information. The fantasy chess peer-to-peer wagering contest information may include audio information. Audio equipment 110 may be used to output audio information. Audio equipment may include speakers found in televisions, speakers for personal computers, cellular phones, PDAs, tablet PCs, or any other suitable audio equipment. The user may use input device 108 to access the fantasy chess and peer-to-peer wagering contest application. Such input devices may include one or more suitable devices such as remote controls, keyboards, voice-controlled devices, track balls, computer mice or any other suitable device. Certain functions such as the user's instructions to make a change in the user's fantasy chess and peer-to-peer wagering contest tournament roster may require user equipment 112 to transmit data to server 103 over communications network 107. If desired, such data may be transmitted using a communications network separate from communications network 107. If functions such as these are provided using communications networks separate from communications network 107, some communications originating from user equipment 112 may be made directly with the separate networks. In one embodiment, the fantasy chess and peer-to-peer wagering contest application of the present invention may be implemented on an interactive television platform. An illustrative fantasy chess and peer-to-peer wagering television system 200 in accordance with this embodiment of the present invention is shown in FIG. 2. Main facility 202 may include a fantasy chess and peer-to-peer wagering contest database 204 for storing fantasy chess and peer-to-peer wagering contest information such as the roster of players available to challenge, the wager or value score for the contest, rules, or any other suitable contest information. Main facility 204 may also include statistical database 204 for storing certain statistics on a pool of players used in a fantasy chess and peer-to-peer wagering contest. Information from databases 203 and 204 may be transmitted to distribution internet provider 205 via communications link 201. Link 201 may be a satellite link, a telephone network link, an Internet link, a cable or fiber optic link, a microwave link, a combination of such links, or any other suitable communications link. The fantasy chess and peer-to-peer wagering contest information transmitted by main facility 202 to internet provider facility 205 includes data which is communicated to users as part of the contest such as statistical information, rosters, player ratings, value points, etc. If desired, some of the contest information may be provided using data sources at facilities other than main facility 202.

For example, data related to tracking player interaction with the contest application and other applications may be communicated to a data collection location that is separate from main facility 202 and separate from internet distribution facility 205. Internet distribution facility 205 may distribute the fantasy chess and peer-to-peer wagering contest application and contest information to user video equipment 210 or other user equipment of multiple users via communications paths 208. This information may be distributed over an out-of-band channel on paths 208 and may be distributed using any of a number of suitable techniques. For example, still images and text may be distributed over an out-of-band channel using an out-of-band modulator. Each user may have a receiver such as a personal computer 210 or other suitable mobile phone or device into which circuitry similar to the computer circuitry has been integrated. For clarity, the present invention is described primarily in connection with user equipment based on a personal computer. This is merely illustrative. The fantasy chess and peer-to-peer wagering contest application may be implemented using a personal computer 210 or handheld computing device, etc. If desired, the fantasy chess and peer-to-peer wagering contest application may be implemented using a client-server architecture using personal computer equipment 210 as a client processor and a server such as server 204.

Communications path 207 preferably has sufficient bandwidth to allow internet provider 205 to distribute content, programming, and other information to personal computer 210 in addition to the fantasy chess and peer-to-peer wagering contest application and related information. Certain functions such as the user's instructions to make a change in his profile or user preferences may require personal computer 210 to transmit data to television distribution facility. The fantasy chess and peer-to-peer wagering contest application of the present invention may also be implemented on an on-line system using personal computers or other suitable equipment linked to a computer network (e.g., the Internet), an interactive application interface (e.g., an Internet browser). With such an arrangement, the fantasy chess and peer-to-peer wagering contest application and related information may be stored remotely on a server that the user of the on-line fantasy chess and peer-to-peer wagering contest application may access through an Internet connection and may download locally. Server 205 could be an Internet connection and a basic personal computer with a browser or other suitable equipment. A number of suitable techniques may be used in the fantasy chess and peer-to-peer wagering system to distribute fantasy chess and peer-to-peer wagering contest information.

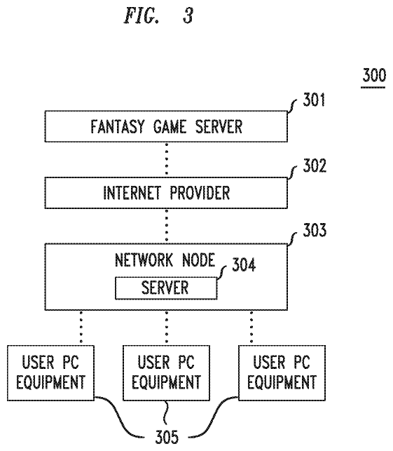

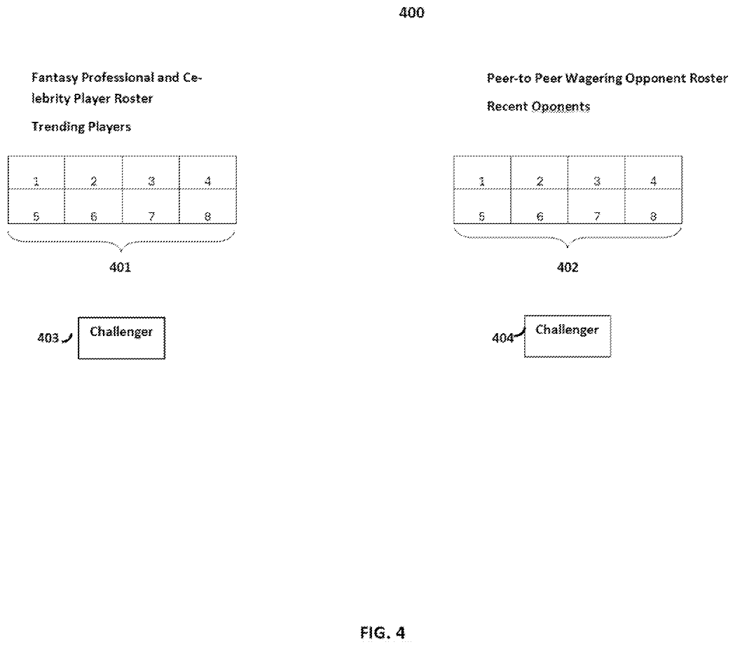

Fantasy chess and peer-to-peer wagering contest information may be downloaded periodically or in real time (e.g., every 30 minutes) to personal computer server 210 and stored. The fantasy chess and peer-to-peer wagering contest information to store may be based on players user wishes to challenge in future matches. The fantasy chess and peer-to-peer wagering contest information may be accessed locally when needed by the fantasy chess and peer-to-peer wagering contest application implemented, at least partially, using the personal computer server 210. Alternatively, fantasy chess and peer-to-peer wagering contest information may be provided in a continuously looped arrangement on one or more digital internet providers 205. With such a continuously looped arrangement, a map indicating the location of the latest fantasy chess and peer-to-peer wagering contest information may be downloaded periodically to a personal computer server 210 (e.g., every thirty minutes). This allows the content and data to be updated constantly. During use of the fantasy chess and peer-to-peer wagering contest application implemented on personal computer display screen 211, information relating to the fantasy chess and peer-to-peer wagering contest may be displayed on display 211. Personal computer 210, and display 211 may be controlled by one or more controls or any other suitable user input interfaces such as a keyboard, mouse, trackball, dedicated set of buttons, etc. Another suitable approach involves using a server such as server 206 or server 304 (FIG. 3) to provide fantasy chess and peer-to-peer wagering contest information on request (e.g., after personal computer 210 and server 206 or server 304 have negotiated to set up a download operation). If desired, server 206 or server 304 may provide instructions to personal computer 210 where the desired fantasy chess and peer-to-peer wagering contest information may be located on a server, a database, or a particular device. The fantasy chess and peer-to-peer wagering contest information may be updated periodically if the server that is responsible for providing the instructions for informing the personal computer of the location of the fantasy chess and peer-to-peer wagering contest information is also updated periodically. As shown in FIG. 3, the capabilities of server 202 may be provided using servers 304 located at network nodes 303. Servers such as servers 304 may be used instead of server 210 or may be used in conjunction with server 206 located at internet provider distribution facility 205. A cable modem may be used to distribute text, graphics, audio and video information. The text, graphics, audio and video information may also be distributed using a combination of these techniques or any other suitable technique. In one embodiment of the present invention, the fantasy chess and peer-to-peer wagering contest application may alert the user of necessary changes in the user's fantasy chess and peer-to-peer wagering contest user account. In one suitable approach, the fantasy chess and peer-to-peer wagering contest application may evaluate the user's ranking profile before the start of an upcoming match to ensure that suitable matchups are identified. By evaluating the user's fantasy chess and peer-to-peer wagering player database, the fantasy chess and peer-to-peer wagering contest application ensures that new and existing match options are constantly updated and available. In one suitable approach, the fantasy chess and peer-to-peer wagering contest application may evaluate the user's tournament player bracket at one preset time or at multiple preset times (e.g., one hour, eight hours, one day) before the start of each round of the fantasy chess and peer-to-peer wagering contest tournament round. In another suitable approach, the fantasy chess and peer-to-peer wagering contest application may alert the user whenever a time slot opens for a match against a desired opponent becomes available. In another suitable approach, the fantasy chess and peer-to-peer wagering application may alert the user when another player is seeking a match or challenging said user to a match. As illustrated by FIG. 4, the fantasy chess and peer-to-peer wagering contest application may display trending players 401 to the user to choose in future contests. In the fantasy chess and peer-to-peer wagering application may display a roster of peer-to-peer opponents 402 to be chosen by the challenger 404 for a match. The fantasy chess and peer-to-peer wagering contest application may provide selectable element 402 in alert message 410.

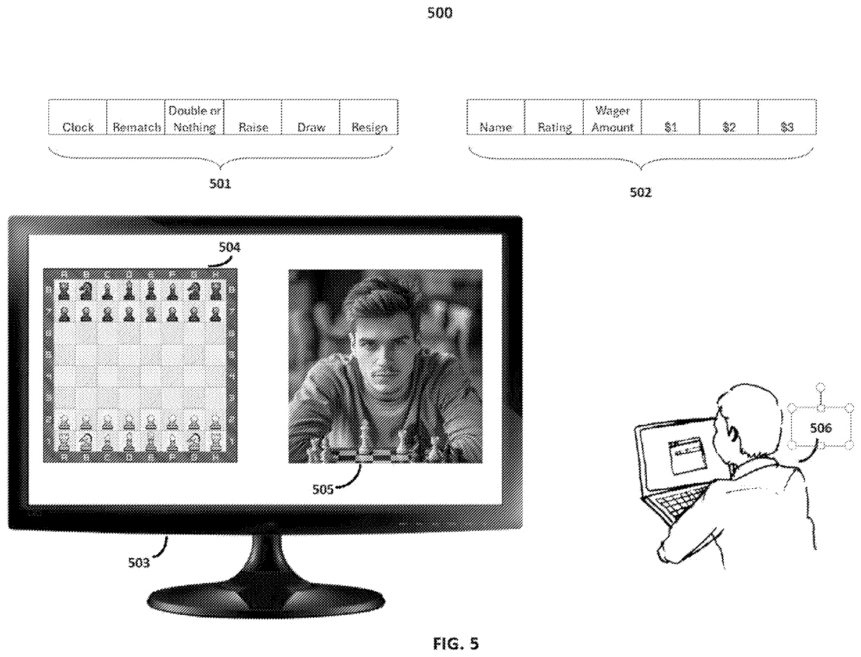

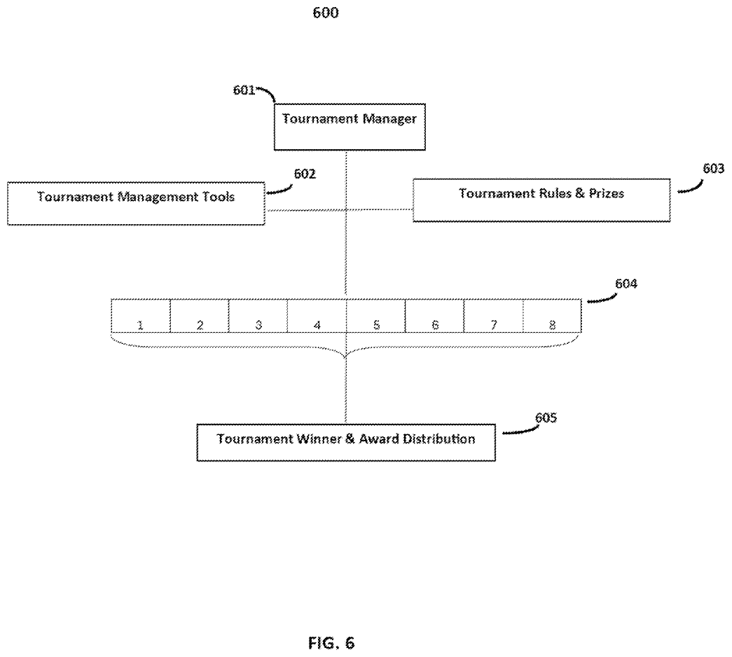

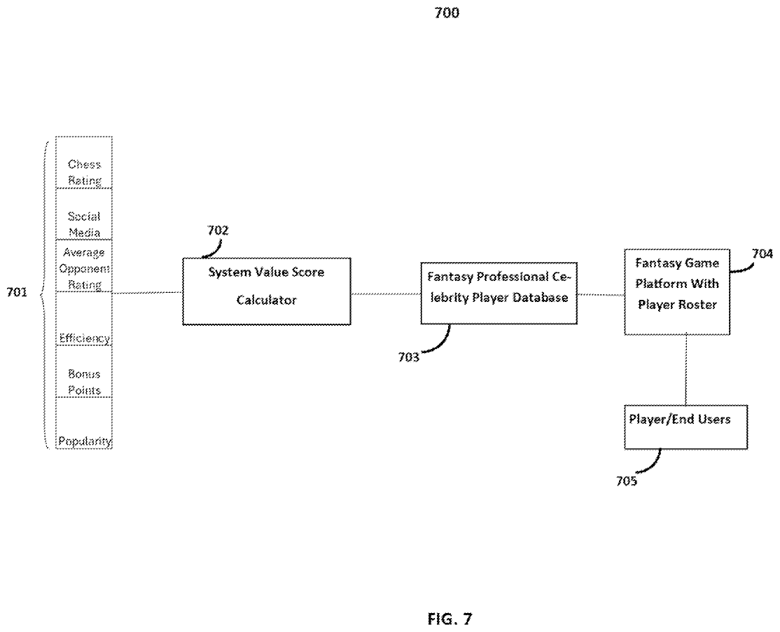

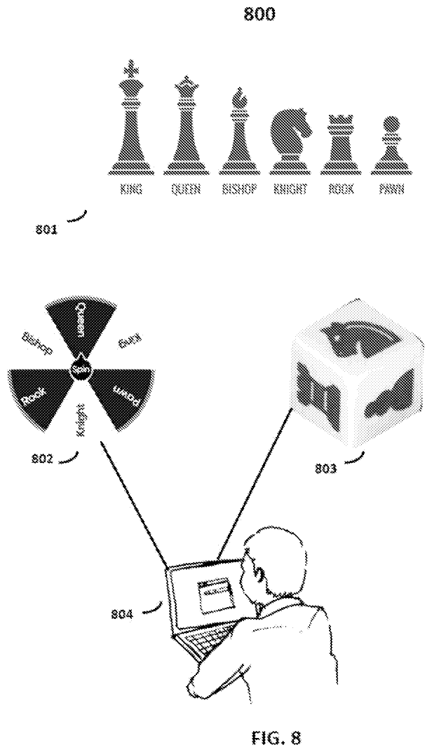

Upon user selection of selectable element 402, the fantasy chess and peer-to-peer wagering contest application may display a screen that enables the user to make the desired choice of player for a match. A personal computer display screen 503 is shown in FIG. 5. As shown in FIG. 5, the fantasy chess and peer-to-peer wagering contest application shows a digital chess board 501 and a live player video feed 502 by which the user will interact face to face with a live player and operate the digital chess game board 504. The fantasy chess and peer-to-peer wagering contest application may include as in figures 501 & 502 buttons with game function and wagering options. In one suitable approach, the user may select the amount of the wager 502, or in another suitable approach, the user may request a rematch 501. In another suitable approach the user may reference a display clock used to track the time lapse in between moves. In another suitable approach the user may challenge the opponent to raise the existing wager 501. If the user decides not to raise the wager or make any other in game adjustments, the match will continue until the outcome of the contest is determined, at which time the user may choose a new action. FIG. 6 is a flow chart of illustrative steps for tournament manager 601 to create a contest involving multiple chess players. The fantasy chess and peer-to-peer wagering contest application allows for the tournament manager to access tournament manger tools 602 to establish or customize the format and guidelines for a tournament style contest. In one suitable approach the tournament manager 601 may select players from a database of players 102 and place them in the tournament bracket 604. The fantasy chess and peer-to-peer wagering contest application utilizes rules 105 for which the tournament operates. The fantasy chess and peer-to-peer wagering contest application allows tournament manager 601 to determine an elimination format and system that results in a tournament winner that will be awarded the predetermined award 605 as well as additional bonus points or currency customized by the tournament manager. In one embodiment of the present invention, the fantasy chess and peer-to-peer wagering contest application seeks to create matches that are fair and competitive. Using detailed statistical information from previous matches on the platform, a user may evaluate various players to determine which players they wish to challenge. Another performance criteria may target a player's performance against common opponents. The use of performance criteria may provide useful insights on a player's strengths and weaknesses that are difficult to discern from general statistical information. Using the targeted statistical information produced using performance criteria, the fantasy chess and peer-to-peer wagering contest application may apply a system for mitigating losses when determining wager amounts. These results may then be averaged to more accurately compare player performance against the performance of other players. Variations of performance criteria are vast, and the performance criteria used by the fantasy chess and peer-to-peer wagering contest application may be pre-programmed, may be selected and edited by the user, or may be provided in any other suitable manner. An illustrative screen for selecting and editing the performance criteria to be used by the fantasy sports contest application is shown in FIG. 7. As seen in FIG. 7, performance criteria categories 701 to be used for ranking and categorizing players will determine various elements or data scores to be used when ranking players as well as determining a player's value score, which is the score that determines the user value or fee for a particular professional or celebrity player. The user fee based on the value score may be paid to the platform and a percentage is paid to the professional celebrity player whereby providing a revenue model for the professional celebrity players. The fantasy chess and peer-to-peer wagering contest application may supply a value score calculator 702 that through a system algorithm will calculate and determine the fee the user will pay to play the professional celebrity player. The fantasy chess and peer-to-peer wagering contest application will utilize the system value score calculator to identify a roster of potential players 703 the user 705 may wish to challenge. This roster will be available to all users across the platform. The fantasy chess and peer-to-peer wagering contest application will also allow the user to customize the fantasy professional celebrity player database 703 and chose players that fall within certain criteria such as score ranges, e.g., a user may only wish to display players with a system value score in a certain range. To evaluate performance in the context of fantasy chess and peer-to-peer wagering, real-life statistics may be converted into fantasy chess and peer-to-peer wagering contest scoring information according to the rules of the fantasy chess and peer-to-peer wagering contest. Alternatively, the fantasy chess and peer-to-peer wagering contest application may use rules or methods for converting real-life statistics to fantasy chess and peer-to-peer wagering contest scoring information that are different from the rules or methods used in the fantasy chess and peer-to-peer wagering contest. Using fantasy chess and peer-to-peer wagering contest scoring information generated from the real-life statistics, the fantasy chess and peer-to-peer wagering contest application may become part of the evaluation formula to generate a value score. In one suitable approach, the fantasy chess and peer-to-peer wagering contest application may use performance scores to generate intelligent recommendations on changes to the user's preferences. Performance scores are calculated using statistics of past performance and may serve as a reasonable recommendation of player matches and a predictor of future performance. One particularly advantageous practice is to, continually or periodically, compare player ratings and performance against common opponents or other players to determine match up advantages or disadvantages when selecting new opponents. In one suitable approach, the fantasy chess and peer-to-peer wagering contest application may compare players by using social media following which is an indicator of a player's popularity on the platform or in general. This data may be used in combination with other data to calculate a player's value score. In another suitable approach the fantasy chess peer-to-peer wagering contest may compare players by using the average opponent rating in combination with other data to calculate the player's value score. In another suitable approach the fantasy chess peer-to-peer wagering contest may utilize move efficiency which is the number of moves on average or matches, which determined the outcome of such matches. FIG. 8 demonstrates the movable pieces of the chess game of which each piece has a value. The fantasy chess and peer-to-peer wagering contest application will provide a device option whereby the game selects and determines on a chance basis, which of the six characters or pieces 801 the player 804 must move next within the game. The random or chance selection of the piece to be moved may alter the strategy and create an advantage or disadvantage for the player. For example, a dice 803 has six sides that instead of numbers on each side, it has the image of each chess character on each side. When the dice is rolled, whichever chess piece or character is facing up, is the piece the player must move next. The same random choice may be made with a wheel 802 containing the names or images of the characters is used to select the next piece to be moved. Such wheels 802, or dice 803 may be created electronically withing the game interface, rather than a physical dice or wheel.

1. A method for using a fantasy chess peer-to-peer wagering contest application to determine a fantasy chess peer-to-peer match, the method comprising:
receiving, via a graphical user interface, at first user television set top box or personal computer equipment, a user input to create a fantasy chess peer-to-peer wagering profile associated with a fantasy chess peer-to-peer wagering contest;
retrieving before a start of a match of the fantasy chess peer-to-peer wagering contest, using control circuitry, data associated with an availability of each player on the fantasy chess peer-to-peer wagering player database;
determining, based on the retrieved data, available players not on the fantasy chess peer-to-peer wagering platform by:
converting real-life statistics of each respective player of the available players to a value score for the respective player considered for the fantasy chess peer-to-peer wagering contest; and
determining whether the value score for the respective player meets performance criteria comprising a weight for the respective player's performance;
identifying, using control circuitry, a beneficial contest to recommend to the user based on the evaluating; and generating for display, in the graphical user interface, an alert to a user, the alert having both a recommended beneficial contest to be made to the fantasy chess peer-to-peer wagering list of preferred or recommended matches and a plurality of selectable elements related to the recommended beneficial value score elements, wherein the alert is automatically displayed on the user interface.

2. The method as in claim 1 further comprising receiving a user selection value score of available players in the player database of the selectable element related to the recommended beneficial match; and updating the fantasy chess peer-to-peer wagering player value score based on, the recommended statistical elements.

3. The method as in claim 1 further comprising creating a fantasy chess peer-to-peer wagering tournament consisting of players selected based on data and elements used in determining the value score of a player to be considered.

4. The method as in claim 1 wherein a novice chess player elects to play a match against a professional celebrity player for a fee determined by the value score of the professional celebrity player.

5. The method as in claim 1 further comprising evaluating, using the control circuitry, available players not on the fantasy chess peer-to-peer wagering player database, comprises converting certain real-life statistics for a real-life player of the chess player database available players to a first score in the fantasy chess peer-to-peer contest in accordance with rules of the fantasy chess peer-to-peer contest.

6. The method as in claim 1 wherein a player in a fantasy chess peer-to-peer contest wagers against their opponent in the contest.

7. The method as in claim 1 wherein a player in a fantasy chess peer-to-peer contest with an existing wager on the match may offer to raise or increase the original wager on the match and the opponent accepts or declines the raise.

8. The method as in claim 1 wherein a player in a fantasy chess peer-to-peer contest wagers against their opponent in the contest and at the conclusion of the contest, a player offers a double or nothing wagering whereby the loser pays double the original wager and the winner receives double the original wager, or the original wager loser paying nothing upon winning the double or nothing rematch.

9. The method as in claim 1 wherein a fantasy chess peer-to-peer wagering match resigns the outcome of a match as a loss thereby forfeiting the wager amount on the game.

10. The method as in claim 1 further comprising accumulating statistical data comprising player value score, player volume of games, or match difficulties to calculate a rewards score entitling the player to certain privileges, prizes, credits, or other values to the player.

11. The method as in claim 1 wherein the fantasy chess peer-to-peer wagering platform comprises a tournament manager using the player value score to choose multiple players for a tournament style competition whereby rules and awards for such tournament are customized for the specific competition.

12. The method as in claim 1 wherein the fantasy chess peer-to-peer wagering contest creates bonus scores for capturing certain pieces of value on the chess game board, such as the king and the queen.

13. The method as in claim 1 wherein the fantasy chess peer-to-peer wagering contests provides for a player with a higher rating offering more favorable wagering odds to a player with a lower rating.

14. A method for compensating professional celebrity players for playing a fantasy chess match against novice players based on the value score the professional celebrity player holds.

15. A method for randomly selecting which chess piece a player must move next thereby altering the player's game strategy as well as odds of the outcome of the game, which is reflected as an additional wager after the start of the game.
